(19) United States
(12) Patent Application Publication
(10) Pub. No.: US 2017/0101342 A1
(43) Pub. Date: Apr. 13, 2017

(54) Cement Board

(71) Applicant: Daniel KIM, Los Angeles, CA (US)

(72) Inventor: Daniel KIM, Los Angelel, CA (US)

(21) Appl. No.: 14/878,190

(22) Filed: Oct. 8, 2015

(51) Int. Cl. C04B 26/02; C04B 26/28

(52) U.S. Cl. CPC C04B 26/026; C04B 26/285; C04B 26/02

(57) ABSTRACT

A cement board is provided, comprising gelatin, fiber material, and ammonium dichromate. The gelatin, the fiber material, and the ammonium dichromate are mixed substantially evenly across and formed into a board by pressure. The gelatin may comprise a mixture of peptides and proteins. The peptides and proteins may be produced by partial hydrolysis of collagen extracted from the skin, bones, and connective tissues of animals. The ammonium dichromate has a formula (NH₄)₂Cr₂O₇. The fiber material may comprise wood fiber. The wood fiber may comprise shredded wood threads. The fiber material may further comprise hemp. The cement board may further comprise fiberglass. The cement board may further comprise pieces of volcanic stones. The cement board may further comprise a mesh embedded therein. The mesh may comprise a metal mesh. The cement board may further comprise plastic cement. The cement board may further comprise adhesive.

### BACKGROUND OF THE INVENTION

The present invention relates to a cement board. More particularly, this invention relates to a cement board, which is strong and light.

Usually, cement boards are very heavy for its main component, that is, cement. Such heaviness has been a serious problem in using them.

Accordingly, a need for a cement board has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a cement board.

Another object of the invention is to provide a cement board, which is strong and light.

Still another aspect of the invention provides a cement board, comprising gelatin, fiber material, and ammonium dichromate. The gelatin, the fiber material, and the ammonium dichromate are mixed substantially evenly across and formed into a board by pressure.

The gelatin may comprise a mixture of peptides and proteins. The peptides and proteins may be produced by partial hydrolysis of collagen extracted from the skin, bones, and connective tissues of animals.

The ammonium dichromate has a formula (NH₄)₂Cr₂O₇.

The fiber material may comprise wood fiber. The wood fiber may comprise shredded wood threads.

The fiber material may further comprise hemp.

The cement board may further comprise fiberglass.

The cement board may further comprise pieces or small granules of volcanic stones.

The cement board may further comprise a mesh embedded therein. The mesh may comprise a metal mesh.

The cement board may further comprise plastic cement. The plastic cement may have about 70% of cement and about 30% of magnesia.

In the cement board the gelatin may be replaced with adhesive, which is aqueous and transparent or clear.

Another aspect of the invention provides a cement board comprising:

plastic cement of approximately 57% of a total weight of the cement board;

fiberglass of approximately 7%;

pieces of volcanic stones of approximately 7%;

shredded wood threads of approximately 18%;

natural fiber hemps of approximately 10%; and

gelatin glue of approximately 1%, comprising about 8 units of gelatin and about one unit of Ammonium Dichromate.

Each of the shredded wood threads may have a dimension of approximately 1 mm×1 mm×1 in.

The shredded wood threads may be soaked in wood preservative and dried.

About 9 ounces of the gelatin glue may be added to about one gallon of water so as to be mixed with other ingredients and dried out to form the cement board.

All the ingredients may be mixed until the plastic cement are converted into dough or stiff paste, which is adapted to roll out the cement board.

The rolled-out cement board may be dried by a superheated steam drying technology, so that the gelatin is to ferment and the cement board turns hard and water resistant.

The metal mesh may comprise galvanized steel chicken wire or non-rusting coating steel wire.

The advantages of the present invention are: (1) the cement board is easy and cheap to manufacture; and (2) the cement board is very strong and light.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a perspective view showing a cement board according to an embodiment of the present invention;

FIG. 2 is a cross-sectional view of FIG. 1 along the line II-II according to an embodiment of the present invention;

FIG. 3 is a cross-sectional view of FIG. 1 along the line II-II according to another embodiment of the present invention;

FIG. 4 is an exemplary diagram showing inside of a cement board according to an embodiment of the present invention;

FIG. 5 is a partial cut-out view of FIG. 1 according to still another embodiment of the present invention;

FIG. 6 is a flow chart showing a method for manufacturing a cement board to still another embodiment of the present invention; and

FIG. 7 is a partial cut-out view of a cement board according to still another embodiment of the present invention.

### DETAILED DESCRIPTION EMBODIMENTS OF THE INVENTION

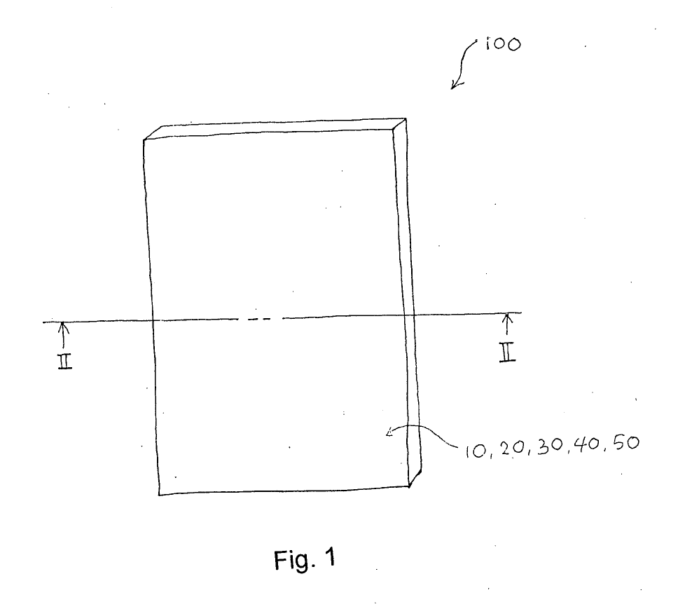

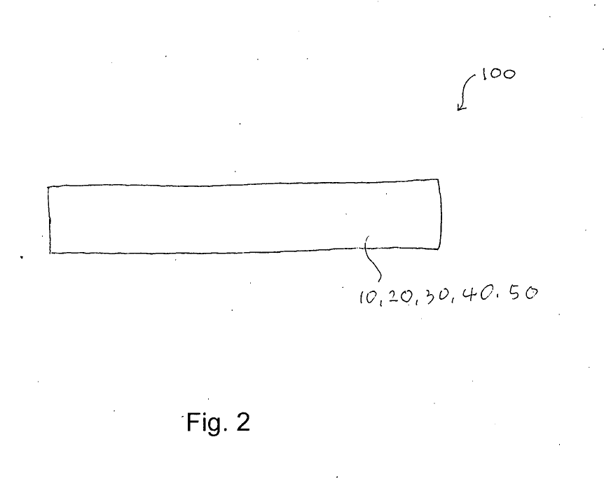

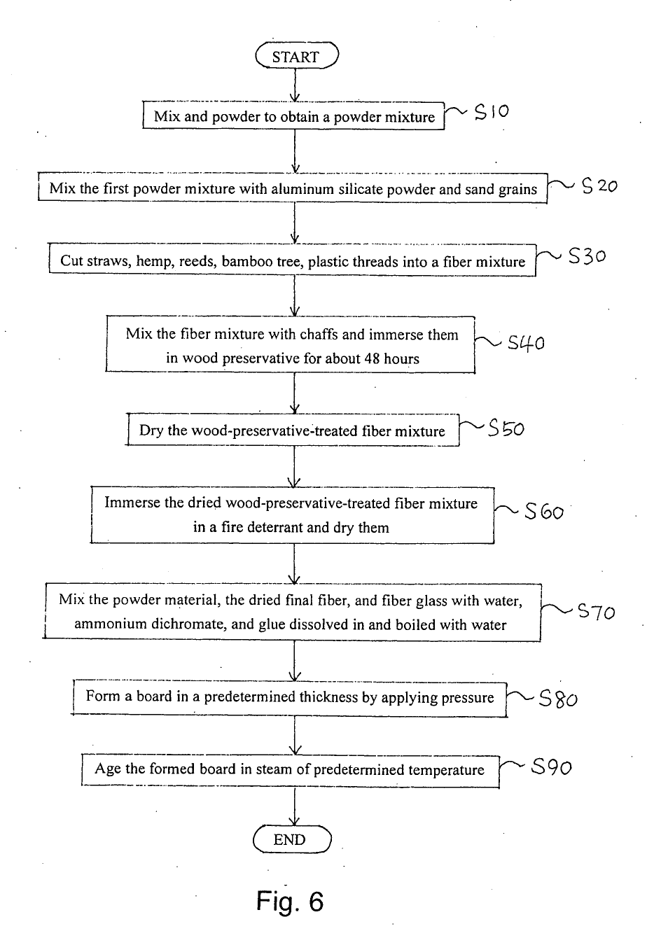

FIGS. 1-5 and 7 show a cement board according to embodiments of the invention, and FIG. 6 shows a method for manufacturing the cement board according to still another embodiment of the invention.

An aspect of the invention provides a cement board 100 as shown in FIGS. 1-5.

The cement board 100 comprises grain material 10, sand grains 12, fiber material 20, fiber glass 22, cement 30, plastic cement 32, glue 40, and ammonium dichromate 50.

The grain material 10 includes aluminum silicate grain, finely crushed bones, shells, dry stall pumice, perlite, coral, and coal ash, or their any possible combination. In general, the grain material 10 is mineral material that is light in weight, such that the cement board 100 would be very light compared to other conventional cement or concrete boards.

The fiber material 20 includes needle-shaped straws, hemp, reeds, bamboo tree, plastic threads, rice hulls, and chaffs, or any possible combination, and the fiber material processed with wood preservative and fire deterrent. In general, the fiber material 20 is also light in weight, of a length longer than width, and strong against tensile force.

The glue 40 performs functions of holding the various components of the board together.

The grain material 10, the fiber material 20, the fiber glass 22, the cement 30, the plastic cement 32, the glue 40, and the ammonium dichromate 50 are mixed substantially evenly and formed into a board 100 by pressure.

The volume ratio of the cement 30 and the plastic cement 32 to the grain material 10, the sand grains 12, and the fiber material 20 may be about 10% to 20% of both in total. Preferably, the volume ratio is about 15% of both in total.

In certain embodiments, the grain material 10 may includes the sand grains 12 as a part.

The volume ratio of the cement 30 to the plastic cement 32 may be about 50% of both in total.

In certain embodiments, the cement 30 may includes the plastic cement 32 as a part.

The volume ratio of the grain material 10 to the fiber material 20 may be about 50% to 70% of both in total. Preferably, the volume ratio is about 65% of both in total.

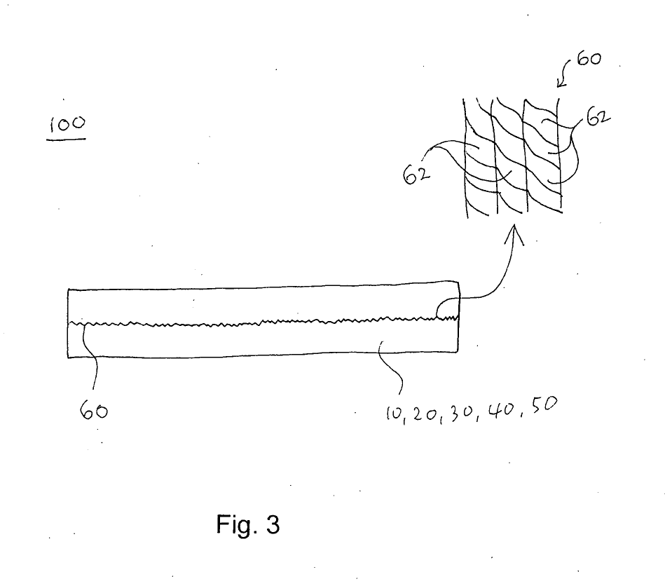

The cement board 100 may further comprise a rust-free-coated metal mesh 60 disposed in a middle of the cement board 100, and the rust-free-coated metal mesh 60 has a plurality of eyes 62 of a predetermined size of substantial portion of an average length of the fiber material 20 as shown in FIG. 3.

In certain embodiments, each of the plurality of eyes 62 may be of the size of about ¼ to ½ of an average length of the fiber material 20.

In certain other embodiments, each of the plurality of eyes 62 may be of the size of about 1.5 to 2.5 of an average length of the fiber material 20.

Therefore, each of the plurality of eyes 62 may take any size between about ¼-½ to about 1.5-2.5 of an average length of the fiber material 20, such that some of the fiber material 20 may be disposed over through the eyes 62 so as to bolster the engagement of both sides of the rust-free-coated metal mesh 60 therethrough.

The glue 40 may be transparent before hardening. In certain embodiments, the glue 40 may be provided in grain or grains, which are melted in water and mixed with the other components evenly.

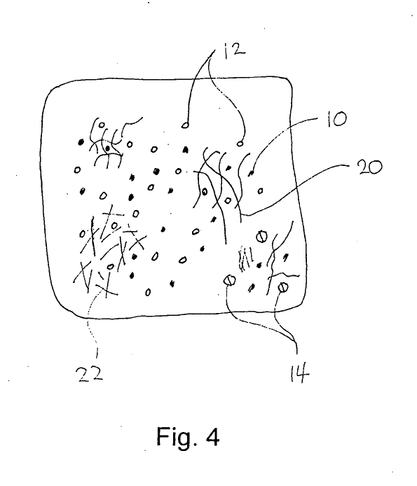

In certain embodiments, the grain material 10 may include the dry stall pumice 14 having different size from the other components of the grain material 10 as shown in FIG. 4.

In certain embodiments, the fiber material 20 may include any tree chips other than the bamboo tree.

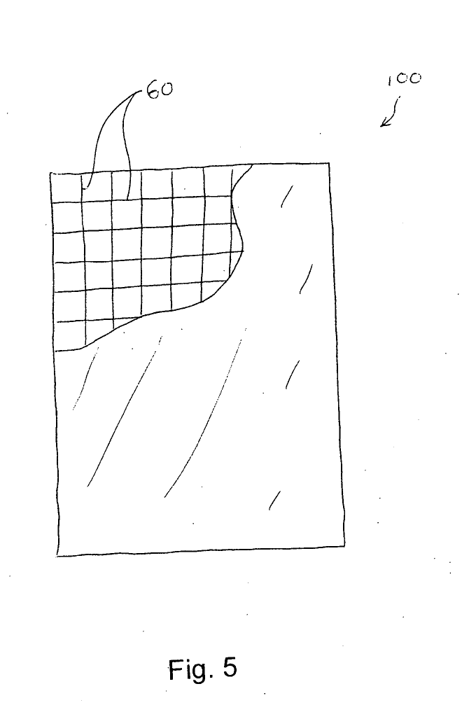

In FIG. 5, a portion of the cement board 100 is taken out to show the metal mesh 50 embedded in the cement board 100.

The metal mesh 50 may be a wire mesh. Also, the shape of the eyes may be square, rectangle, hexagon, etc.

And, the eye size of the metal mesh 50 is from about ⅓ to about 2 of the size of an average length of the fiber material.

The wood preservative keeps the wood or plant material from decaying or being degraded by termites.

The even mixture of the glue and the ammonium dichromate provides the cement board with waterproof.

Another aspect of the invention provides a method for manufacturing cement board as shown in FIG. 6.

The method comprises steps for:

mixing and graining finely crushed bones, shells, dry stall pumice, perlite, coral, and coal ash to obtain a grain mixture (S10);

mixing the first grain mixture with aluminum silicate grain and sand grains to obtain a grain material (S20);

cutting straws, hemp, reeds, bamboo tree, plastic threads into a fiber mixture of predetermined length (S30);

mixing the fiber mixture with chaffs and immersing them in wood preservative for about 48 hours to obtain wood-preservative-treated fiber mixture (S40);

drying the wood-preservative-treated fiber mixture (S50);

immersing the dried wood-preservative-treated fiber mixture in a fire deterrent and drying them to obtain a final fiber mixture (S60);

mixing the grain material, the dried final fiber, and fiber glass, ammonium dichromate, and glue dissolved in and boiled with water (S70);

forming a board in a predetermined thickness by applying pressure (S80); and

aging the formed board in steam of predetermined temperature (S90).

The volume ratio of the cement and the plastic cement to the grain material, the sand grains, and the fiber material may be about 10% to 20% of both in total, preferably 15%.

The volume ratio of the cement to the plastic cement may be about 50% of both in total.

The volume ratio of the grain material to the fiber material may be about 50% to 70% of both in total, preferably 65%.

The method may further comprise a step for inserting a metal mesh in a middle of the mixed material before the step for forming.

The method may further comprise a step for coating the metal mesh so as to make the metal mesh rust-free.

In certain embodiments, the reeds may be placed with other fibrous plants with strong fibers in them.

Still another aspect of the invention provides a cement board, comprising gelatin, fiber material, and ammonium dichromate. The gelatin, the fiber material, and the ammonium dichromate are mixed substantially evenly across and formed into a board by pressure.

The gelatin may comprise a mixture of peptides and proteins. The peptides and proteins may be produced by partial hydrolysis of collagen extracted from the skin, bones, and connective tissues of animals.

The ammonium dichromate has a formula (NH₄)₂Cr₂O₇.

The fiber material may comprise wood fiber. The wood fiber may comprise shredded wood threads.

The fiber material may further comprise hemp.

The cement board may further comprise fiberglass.

The cement board may further comprise pieces of volcanic stones.

The cement board may further comprise a mesh embedded therein. The mesh may comprise a metal mesh.

The cement board may further comprise plastic cement. The plastic cement may have about 70% of cement and about 30% of magnesia.

The cement board may further comprise adhesive.

Another aspect of the invention provides a cement board comprising:

plastic cement of approximately 57% of a total weight of the cement board;

fiberglass of approximately 7%;

pieces of volcanic stones of approximately 7%;

shredded wood threads of approximately 18%;

natural fiber hemps of approximately 10%; and

gelatin glue of approximately 1%, comprising about 8 units of gelatin and about one unit of Ammonium Dichromate.

Each of the shredded wood threads may have a dimension of approximately 1 mm×1 mm×1 in.

The shredded wood threads may be soaked in wood preservative and dried.

About 9 ounces of the gelatin glue may be added to about one gallon of water so as to be mixed with other ingredients and dried out to form the cement board.

All the ingredients may be mixed until the plastic cement are converted into dough or stiff paste, which is adapted to roll out the cement board.

The rolled-out cement board may be dried by a superheated steam drying technology, so that the gelatin is to ferment and the cement board turns hard and water resistant.

Superheated steam is steam at a temperature higher than the vaporization point at the absolute pressure where the temperature is measured. Therefore, the steam can cool by some amount, resulting in a lowering of its temperature without changing state from a gas, to a mixture of saturated vapor and liquid.

The metal mesh may comprise galvanized steel chicken wire or non-rusting coating steel wire.

Since the cement board is made by forming in a dough or stiff paste as a board and then drying or hardening through the superheated steam drying technology, the cement board is made a single monolithic body, not assembled. Therefore, the cement board is light-weighted and strong and can be installed very easily.

The gelatin may be the most important ingredient for the hardening process of the cement board. Ammonium Dichromate is to make hardened surface of the cement panel or board and therefore the moisture or water cannot pentrate it. This keeps the moisture and/or water out of the cement board.

The basic process involves mixing all of the ingredients until the cement is converted into a dough or stiff paste. It also must be elastic and stable enough to hold its shape or it could easily roll out.

The cement panels may be made to have desired thickness and size; ⅜ inch to ¾ inch×4 feet×8 feet.

The metal mesh or the chicken wire mesh or grid may have a dimension of 1½ inch to 2 inch mesh or grid×27 to 23 wire gauge.

The metal mesh may be embedded in the center of the paste cement panel. Then appropriate pressure is applied to make the desired shape and desired size, and the cement panel is let to dry under the pressure applied.

Superheated steam drying technology is simultaneously used to get an appropriate gelatin formentation.

Final processing for the surface may include scratching the outside of the cement panel to be finished for stucco.

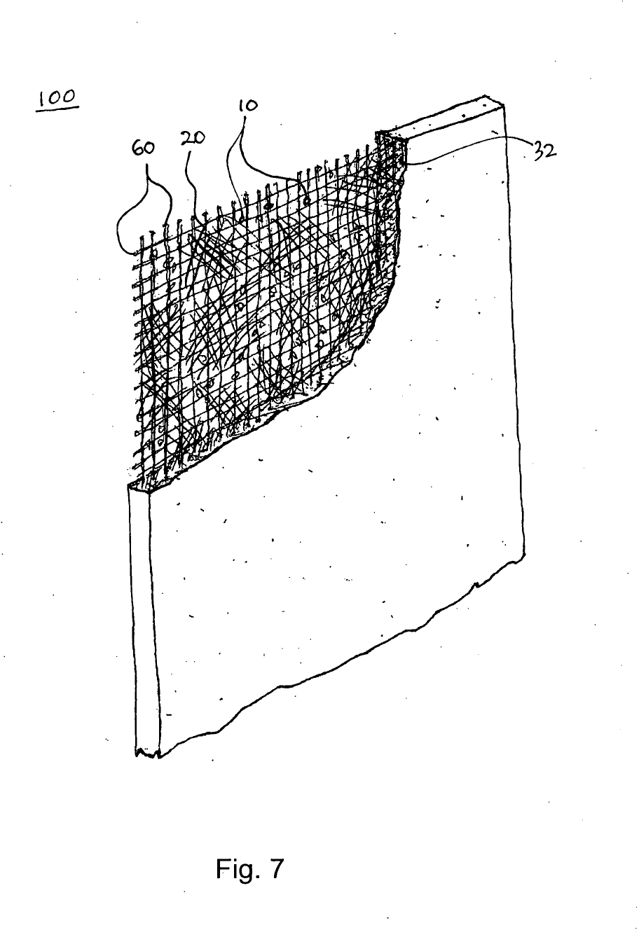

As shown in FIG. 7, the fiber material 20 of the cement board 100 may comprise plastic threads or strands 20′ or chaffs 20″. The plastic threads or strands 20′ may be provided in various lengths. The plastic threads or strands 20′ may be made of polyester threads.

Of course the fiber material 20 may include just any one or two out of wood fiber, plastic threads, rice hulls, and chaffs.

The ingredients from plants are treated by preservatives, but those from animals don't have to be so.

In the process of making the cement board under pressure, more cement or plastic cement tend to ooze out to the surface of the cement board, making the outer surface of the cement board smoother.

In some embodiment, the metal mesh may be omitted. Such cement board may be used for inside of a building. Of course, since the cement board with metal mesh is more sturdy against potential intrusion of any kinds from outside, they may be used on the outermost portion of the wall of the building.

In certain embodiment, the pieces of volcanic stones can be replaced with other light material such as pumice and ceramic material.

Still another aspect of the invention provide a method for manufacturing cement board.

The method comprises steps for:

(1) cleaving hemp, wood, hard wood, and bamboo tree into needle-shapes having about 1 mm thickness about 1 inch length, mixing 90% of them with about 10% of rice hulls or chaffs, immersing all of them in wood preservative, and drying them;

(2) preparing plastic threads (about 1 mm thick) and fiber glass by cutting them by about 1 inch;

(3) preparing volcanic stones, pumice, or light floatstones broken into pieces;

(4) boiling the gelatin in a double boiler so as to turn it into thick liquid or gel and mixing it with ammonium dichromate;

(5) preparing plastic cement by mixing cement and magnesia by the ratio of about 7:3;

(6) mixing the prepared ingredients of (1) to (5) with water, placing one or two metal mesh of non-rusting coating steel wire or chicken wire, forming a board under high pressure for about 24 hours; and

(7) fermenting the formed cement board in hot steam for about 10 hours.

Gelatin and ammonium dichromate and all other ingredients are mixed with water and then they are heated by steam, so that the gelatin is fermented by the ammonium dichromate, and when it is dried completely, the cement board or panel is water resistant and very strong.

Each of the pieces or small granules of volcanic stones is porous, including many pores formed therein. The main function of such an ingredient is to reduce the weight of the cement board, and also the pores introduce other ingredients therein and strengthen the cement board.

Still another aspect of the invention provide a method for manufacturing cement board.

The method comprises steps for:

(1) boiling the gelatin in a double boiler so as to turn it into thick liquid or gel and mixing it with ammonium dichromate in a ratio from about 10:1 to about 100:1;

(2) cleaving hemp, wood, hard wood, and bamboo tree into needle-shapes having about 1 mm thickness about 1 inch length, mixing 100% of them with about 15% of rice hulls or chaffs;

(2-A) immersing all of them in wood preservative for about 10 hours, and drying them;

(2-B) immersing all of them in the liquid of (1) for longer than 3 hours, drying them in sunlight going through them, so that they turn into water-proof;

(3) preparing plastic threads and fiber glass by cutting them by about 1 mm thick and about 1 inch, and applying (2) and (3) into this with enough of fire deterrent and drying them all;

(4) preparing volcanic stones, pumice, or light floatstones (or light mineral materials) broken into pieces of sizes of sands;

(5) preparing plastic cement by mixing cement and magnesia by the ratio of about 7:3;

(6) mixing the prepared ingredients of (1) to (5) with water;

(7) mixing water of appropriate amount with (1);

(8) placing one or two metal mesh of non-rusting coating steel wire or chicken wire, forming a board under high pressure for about 48 hours; and

(9) fermenting the formed cement board in hot steam for over about 10 hours, which would not be rotten, and would be water-proof, fire-proof, and strong.

In certain embodiments of the invention, the cement board may further comprise cement. The cement or the plastic cement are disposed in between the fiber material. The fiber material 20 including needle-shaped straws, hemp, reeds, bamboo tree, plastic threads, rice hulls, and chaffs, or any possible combination are strewn randomly in the block of cement board, so that the cement or plastic cement permeate between needle-shaped fiber material, making a strong and unbreakable board.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A cement board comprising:
gelatin;
fiber material; and
ammonium dichromate,
wherein the gelatin, the fiber material, and the ammonium dichromate are mixed substantially evenly across and formed into a board by pressure.

2. The cement board of claim 1, wherein the gelatin comprises a mixture of peptides and proteins, and wherein the peptides and proteins are produced by partial hydrolysis of collagen extracted from the skin, bones, and connective tissues of animals.

3. The cement board of claim 1, wherein the ammonium dichromate has a formula (NH₄)₂Cr₂O₇.

4. The cement board of claim 1, wherein the fiber material comprises wood fiber, plastic threads, rice hulls, and chaffs.

5. The cement board of claim 4, wherein the wood fiber comprises shredded wood threads.

6. The cement board of claim 4, wherein the fiber material further comprises hemp.

7. The cement board of claim 6, further comprising fiberglass.

8. The cement board of claim 7, further comprising pieces or granules of volcanic stones.

9. The cement board of claim 9, further comprising a mesh embedded therein.

10. The cement board of claim 9, wherein the mesh comprises a metal mesh.

11. The cement board of claim 10, further comprising plastic cement.

12. The cement board of claim 11, wherein the cement board are made of:
the plastic cement of approximately 35% of a total weight of the cement board;
the pieces or granules of volcanic stones of approximately 15%; and
the rest of ingredients of approximately 50%.

13. A cement board comprising:
plastic cement of approximately 57% of a total weight of the cement board;
fiberglass of approximately 7%;
pieces of volcanic stones of approximately 7%;
shredded wood threads of approximately 18%;
natural fiber hemps of approximately 10%; and
gelatin glue of approximately 1%, comprising about 8 units of gelatin and about one unit of Ammonium Dichromate,
wherein the cement board is manufactured by mixing all of the ingredients and forming under a specific pressure.

14. The cement board of claim 13, wherein each of the shredded wood threads has a dimension of approximately 1 mm×1 mm×1 in.

15. The cement board of claim 14, wherein the shredded wood threads are soaked in wood preservative and dried.

16. The cement board of claim 13, wherein about 9 ounces of the gelatin glue is added to about one gallon of water so as to be mixed with other ingredients and dried out to form the cement board.

17. The cement board of claim 16, wherein all the ingredients are mixed until the plastic cement are converted into dough or stiff paste, which is adapted to roll out the cement board.

18. The cement board of claim 17, wherein the rolled-out cement board is dried by a superheated steam drying technology, so that the gelatin is to ferment and the cement board turns hard and water resistant.

19. The cement board of claim 13, wherein the metal mesh comprises galvanized steel chicken wire or non-rusting coating steel wire.

20. A method for manufacturing a cement board, the method comprising steps for:
(1) boiling gelatin in a double boiler so as to turn it into thick liquid or gel and mixing it with ammonium dichromate in a ratio of about 100:1;
(2) cleaving hemp, wood, hard wood, and bamboo tree into needle-shapes having about 1 mm thickness about 1 inch length, mixing 100% of them with about 15% of rice hulls or chaffs;
(2-A) immersing all ingredients from Step (2) in wood preservative for about 10 hours, and drying;
(2-B) immersing all ingredients from Step (2-A) in the liquid of (1) for longer than about 3 hours, drying in sunlight, so that the mixture turns into water-proof;
(3) preparing plastic threads and fiber glass by cutting by about 1 mm thick and about 1 inch, and mixing with (2-B) and (3) with enough of fire deterrent and then drying;
(4) preparing volcanic stones, pumice, or light floatstones broken into pieces of sizes of sands;
(5) preparing plastic cement by mixing cement and magnesia by the ratio of about 7:3;
(6) mixing all ingredients prepared in (1) to (5) with water;
(7) placing one or two metal mesh of non-rusting coating steel wire or chicken wire, forming a board under high pressure for about 48 hours; and
(8) fermenting the formed cement board in hot steam for over about 10 hours, which would not be rotten, and would be water-proof, fire-proof, and strong.
